(19) United States
(12) Patent Application Publication
(10) Pub. No.: US 2023/0017351 A1
(43) Pub. Date: Jan. 19, 2023

(54) METHOD FOR FABRICATING POLARIZING LAYER INCLUDING A PROTECTIVE LAYER

(71) Applicant: SHARP KABUSHIKI KAISHA, Sakai City (JP)

(72) Inventors: MIHO YAMADA, Sakai City (JP); MASAHIRO HASEGAWA, Sakai City (JP); AKIRA HIRAI, Sakai City (JP); AKIRA SAKAI, Sakai City (JP)

(21) Appl. No.: 17/379,851

(22) Filed: Jul. 19, 2021

(51) Int. Cl. G02B 5/30

(52) U.S. Cl. CPC G02B 5/3041; G02B 5/3083

(57) ABSTRACT

A polarizing plate includes a polarizing layer over a base material, an inorganic insulation layer over the polarizing layer, and a water-resistant layer over the inorganic insulation layer, where the water-resistant layer covers sidewalls of the polarizing layer and sidewalls of the inorganic insulation layer, when the base material is viewed from a top plan view.

### FIELD

The present disclosure is related to a method of fabricating polarizing layer including a protective layer using dry etching technique.

### BACKGROUND

A lyotropic liquid crystal dye type polarizing plate is water-soluble after coating such that it easily dissolves in water, even in a state of dry film. The surface layer can be covered with an overcoating (e.g., protective film). However, considering the practical process of cutting into a very large size after coating, it is inevitable that the end surfaces are exposed, thus will eventually be infiltrated, eroded, and/or dissolved by water on the exposed surface.

To solve this problem, a method of insolubilization treatment of the entire polarizing plate by ion exchange is known. However, this method is problematic since the optical properties of the polarizing plate are deteriorated, thereby resulting in decrease in quality, unevenness, and decrease in two-color ratio. Another potential problem is that the process requires low temperature equipment (hereinafter referred to as “issue 1”).

Instead of insolubilization treatment, a method of applying the overcoating to cover both surface layers and end surfaces of the polarizing plate after patterning the polarizing plate in order to leave only the area required for the product may be applicable. However, a normal patterning method (e.g., patterning an organic resist as a mask) has the following problems. In a case of dry etching, an etching rate of the polarizing plate is low, such that the organic resist is lost first (hereinafter referred to as “issue 2”). In a case of wet etching, the precision of the end portions is inaccurate (hereinafter referred to as “issue 3”). When the overcoating layer is applied after patterning, the process becomes longer, thereby increasing manufacturing cost and decreasing yield ratio (hereinafter referred to as issue 4″).

In order to address the above-mentioned issues, Japanese published unexamined application 2011-164269 describes that in order to prevent reflection and interference of the polarizing layer, a coating material containing inorganic fine particles, or the like, is applied on the polarizing layer (see, e.g. para. [0045]). Since the main constituent material is usually an organic material such as acrylic resin (see, e.g. para. [0046]), the material hardness is insufficient, such that the coating material containing inorganic particles cannot withstand dry etching as noted in issue 2.

Furthermore, Japanese patent 5422875 describes materials of insolubilized treatment solution for insolubilization treatment of a coated polarization layer. However, as described therein, the performance and quality of the polarizing layer decreases.

Furthermore, Japanese published unexamined application 2007-234870 describes a method of dry etching using inorganic layers such as SiO and SiN to reduce the speed of dry etching. However, this method has never been tried on a coated polarizing plate. There is a possibility that film floating occurs when laminating an inorganic layer directly to the polarizing layer.

### SUMMARY

The present disclosure is directed to a polarizing plate and a method of manufacturing a polarizing plate having a polarizing layer over a base material, a first inorganic insulation layer over the polarizing layer, and a water-resistant layer, and a water-resistant layer over the first inorganic insulation layer, wherein the water-resistant layer covers sidewalls of the polarizing layer and sidewalls of the first inorganic insulation layer, when the base material is viewed from a top plan view, as shown in and/or described in connection with at least one of the figures, and as set forth in the claims.

In one implementation of the present disclosure, a method of protecting only the end portions after patterning without insolubilization treatment s described.

In one implementation of the present disclosure, a patterning method for using the inorganic layer as a mask is described.

In one implementation of the present disclosure, a method of overlapping decorative printing on the end portions is described.

In one implementation of the present disclosure, a method of combining overcoating at the end portions with decorative printing ink is described.

In one implementation of the present disclosure, a combining any of the above patterning methods and treating the end portions with an insolubilization treatment solution is described.

### BRIEF DESCRIPTION OF THE DRAWINGS

FIG. 1 illustrates a cross-sectional view of a polarizing structure including a protective layer according to an example implementation of the present disclosure.

FIG. 2 illustrates a flowchart of an example method of fabricating a polarizing structure including a protective layer according to an example implementation of the present disclosure.

FIG. 3A(i) illustrates a top plan view of a portion of a polarizing structure processed in accordance with the flowchart of FIG. 2 according to one implementation of the present application.

FIG. 3A(ii) illustrates a cross-sectional view of the polarizing structure in FIG. 3A(i).

FIG. 3B(i) illustrates a top plan view of a portion of a polarizing structure processed in accordance with the flowchart of FIG. 2 according to one implementation of the present application.

FIG. 3B(ii) illustrates a cross-sectional view of the polarizing structure in FIG. 3B(i).

FIG. 3C(i) illustrates a top plan view of a portion of a polarizing structure processed in accordance with the flowchart of FIG. 2 according to one implementation of the present application.

FIG. 3C(ii) illustrates a cross-sectional view of the polarizing structure in FIG. 3C(i).

FIG. 3D(i) illustrates a top plan view of a portion of a polarizing structure processed in accordance with the flowchart of FIG. 2 according to one implementation of the present application.

FIG. 3D(ii) illustrates a cross-sectional view of the polarizing structure in FIG. 3D(i).

FIG. 3E(i) illustrates a top plan view of a portion of a polarizing structure processed in accordance with the flowchart of FIG. 2 according to one implementation of the present application.

FIG. 3E(ii) illustrates a cross-sectional view of the polarizing structure in FIG. 3E(i).

FIG. 4A illustrates a cross-sectional view of a portion of a polarizing structure processed in accordance with an example fabrication method of the present disclosure.

FIG. 4B illustrates a cross-sectional view of a portion of a polarizing structure processed in accordance with the example fabrication method of the present disclosure.

FIG. 4C illustrates a cross-sectional view of a portion of a polarizing structure processed in accordance with the example fabrication method of the present disclosure.

FIG. 4D illustrates a cross-sectional view of a portion of a polarizing structure processed in accordance with the example fabrication method of the present disclosure.

FIG. 5A illustrates a cross-sectional view of a polarizing structure with a protective layer according to an example implementation of the present disclosure.

FIG. 5B illustrates a cross-sectional view of a polarizing structure with a protective layer according to an example implementation of the present disclosure.

FIG. 5C illustrates a cross-sectional view of a polarizing structure with a protective layer according to an example implementation of the present disclosure.

FIG. 5D illustrates a cross-sectional view of a polarizing structure with a protective layer according to an example implementation of the present disclosure.

FIG. 5E illustrates a cross-sectional view of a polarizing structure with a protective layer according to an example implementation of the present disclosure.

FIG. 5F illustrates a cross-sectional view of a polarizing structure with a protective layer according to an example implementation of the present disclosure.

FIG. 6 illustrates a cross-sectional view of a polarizing structure with a protective layer according to an example implementation of the present disclosure.

FIG. 7 illustrates a cross-sectional view of a polarizing structure having a polarizer layer with water insoluble sidewalls according to an example implementation of the present disclosure.

### DESCRIPTION

The present disclosure is directed to a method for fabrication of a polarizer stack including a protective layer. The following disclosure contains specific information related to implementations of the present disclosure. One skilled in the art will recognize that the present disclosure may be implemented in a manner different from that specifically disclosed in the present disclosure. Moreover, some specific details are not disclosed in order to not obscure the present disclosure. The specific details not disclosed in the present disclosure are within the knowledge of a person of ordinary skill in the art.

The drawings in the present disclosure and their accompanying detailed description are directed to merely example implementations of the present disclosure. To maintain brevity, other implementations of the present disclosure which use the principles of the present disclosure are not specifically disclosed and are not specifically illustrated by the drawings.

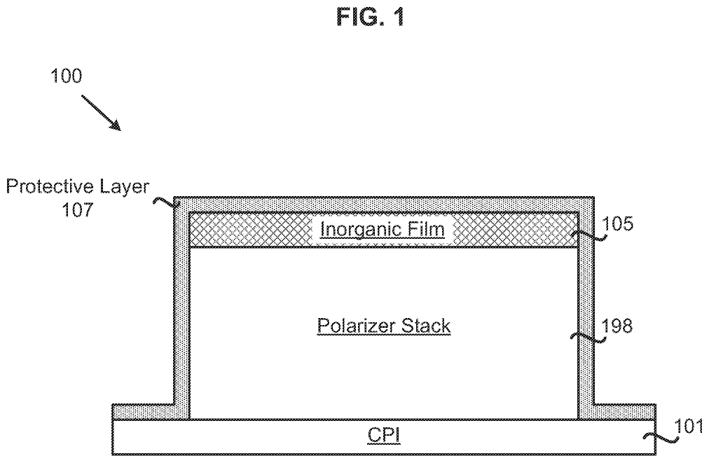

FIG. 1 illustrates a cross-sectional view of a polarizing structure 100 having a protective layer, according to an example implementation of the present disclosure. The polarizing structure 100 includes an inorganic layer 105, a polarizer stack 198 and a base material 101 (e.g., a CPI layer), and is coated with a protective layer 107 that covers all exposed surfaces (e.g., top and side surfaces) of the inorganic layer 105, the polarizer stack 198 and the base material 101. It should be noted that if the sidewalls of the inorganic layer 105 and the polarizer stack 198 are exposed and unprotected by the protective layer 107, the sidewalls of the inorganic layer 105 and the polarizer stack 198 would be susceptible to water infiltration and erosion, for example. Thus, the protective layer 107 (e.g., a water-resistant layer) is configured to protect he inorganic layer 105 and the polarizer stack 198 from water invasion.

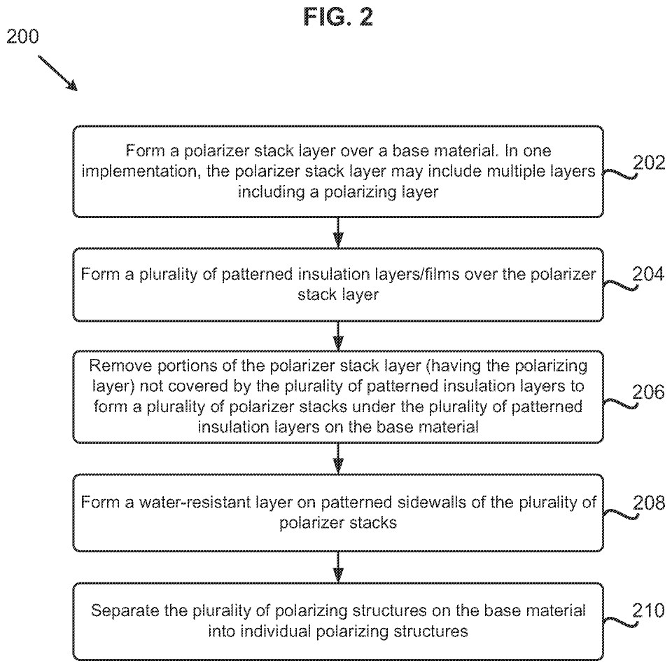

FIG. 2 illustrates a flowchart 200 of an example method of fabricating a polarizing structure including a protective layer according to an example implementation of the present disclosure. As illustrated in FIG. 2, the flowchart 200 includes actions 202, 204, 206, 208, and 210. Action 202 includes forming a polarizer stack layer over a base material. In one implementation, the polarizer stack layer may include multiple layers including a polarizing layer. Action 204 includes forming a plurality of patterned insulation layers/films over the polarizer stack layer. Action 206 includes removing portions of the polarizer stack layer (having the polarizing layer) not covered by the plurality of patterned insulation layers to form a plurality of polarizer stacks under the plurality of patterned insulation layers on the base material. It should be understood that there is a polarizing layer in each of the plurality of polarizer stacks. Action 208 includes forming a water-resistant layer on patterned sidewalls of the plurality of polarizer stacks. Action 210 includes separating the plurality of polarizing structures on the base material into individual polarizing structures, for example, by sawing or cutting.

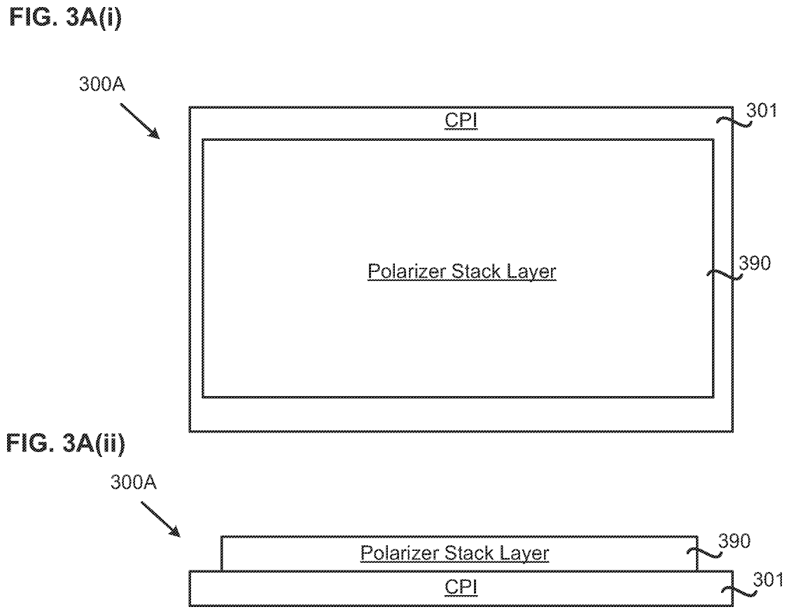

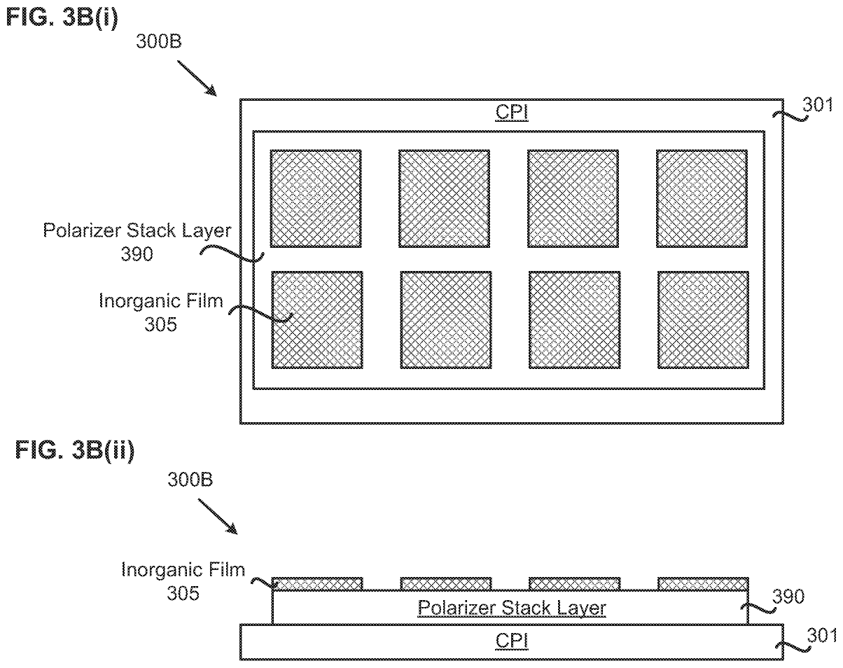

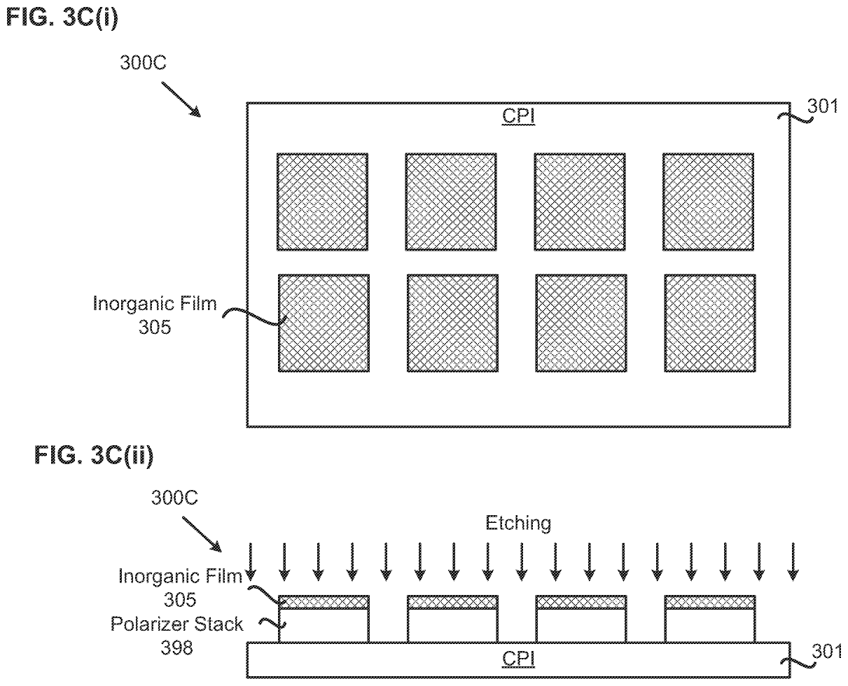

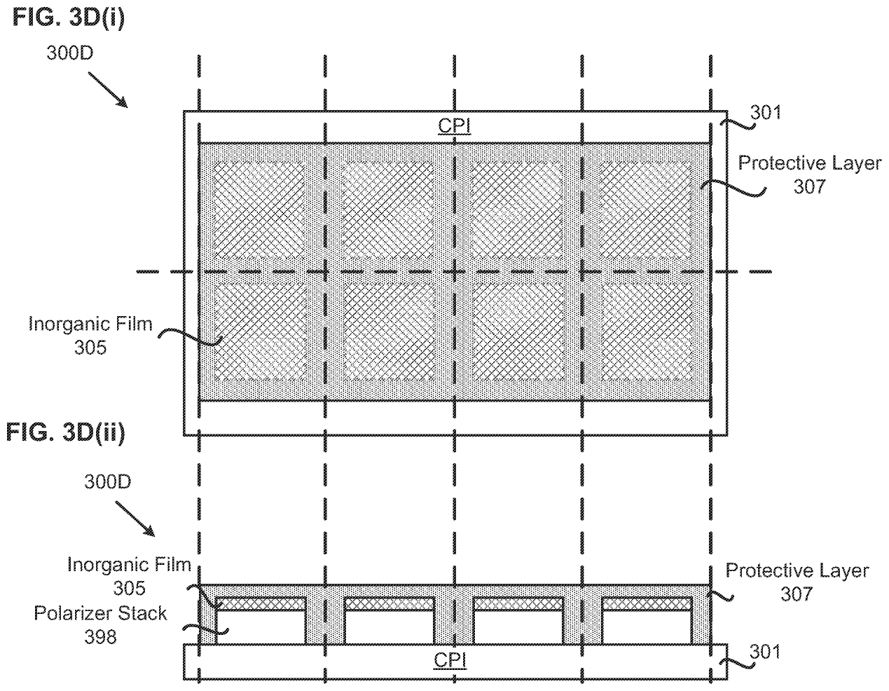

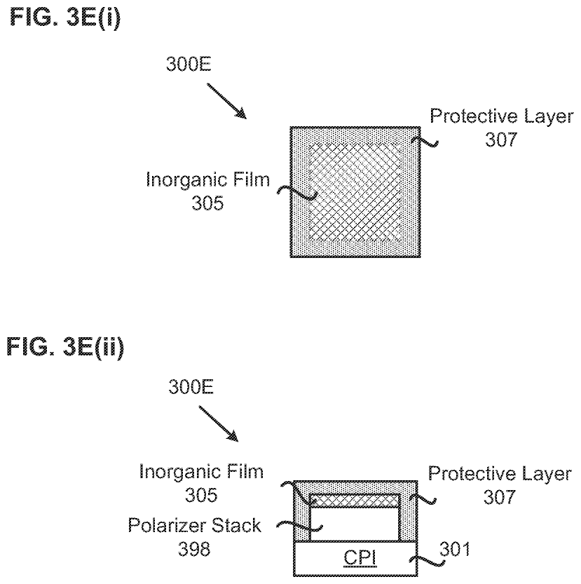

FIGS. 3A-3E each illustrate a portion of a polarizing structure processed in accordance with the flowchart of FIG. 2 according to one implementation of the present application.

FIG. 3A(i) illustrates a top plan view of a portion of a polarizing structure 300A processed in accordance with action 202 in the flowchart 200 of FIG. 2 according to one implementation of the present application. FIG. 3A(ii) illustrates a cross-sectional view of the polarizing structure 300A in FIG. 3A(i). As illustrated in FIG. 3A(i), a polarizing structure 300A includes a polarizer stack layer 390 and a base material 301 (e.g., a CPI layer). The polarizer stack layer 390 may cover the entire surface of the base material 301. As illustrated in FIG. 3A(ii), the polarizer stack layer 390 is provided on top of the base material 301.

FIG. 3B(i) illustrates a top plan view of a portion of a polarizing structure 300B processed in accordance with action 204 in the flowchart 200 of FIG. 2. FIG. 3B(ii) illustrates a cross-sectional view of the polarizing structure 300B in FIG. 3B(i). As illustrated in FIG. 3B(i), a plurality of patterned inorganic layers 305 are provided on top of the polarizer stack layer 390 on the base material 301. In FIG. 3B(ii), the patterned inorganic layers 305 are provided on top of the polarizer stack layer 390 that is placed on the base material 301.

FIG. 3C(i) illustrates a top plan view of a portion of a polarizing structure 300C processed in accordance with action 206 in the flowchart 200 of FIG. 2. FIG. 3C(ii) illustrates a cross-sectional view of the polarizing structure 300C in FIG. 3C(i). In FIG. 3C(i), the plurality of patterned inorganic layers 305 provided on top of the plurality of polarizer stacks 398 acts as a plurality of masking layers during an etching process (e.g., dry or wet etching) such that the portions of the polarizer stack layer 390 not covered by the patterned inorganic layers 305 are removed as a result of the etching process. As illustrated in FIG. 3C(ii), the plurality of polarizer stacks 398 covered by the inorganic layers 305 remain on the base material 301 after the etching process, while the portions of the polarizer stack layer 390 not covered by the patterned inorganic layers 305 are removed.

FIG. 3D(i) illustrates a top plan view of a portion of a polarizing structure 300D processed in accordance with action 208 in the flowchart 200 of FIG. 2. FIG. 3D(ii) illustrates a cross-sectional view of the polarizing structure 300D in FIG. 3D(i). As illustrated in FIG. 3D(i), a protective layer 307 (e.g., a water-resistant layer) is provided on the polarizing structure 300C of FIG. 3C(i). The protective layer 307 is provided on the polarizing structure 300C of FIG. 3C(ii). In FIGS. 3D(i) and 3D(ii), the protective layer 307 is provided on top of the inorganic layers 305 and the base material 301. The protective layer 307 also fills in the spaces between the etched polarizer stacks 398 covering the sidewalls of the inorganic layers 305 and the etched polarizer stacks 398. The protective layer 307 also covers the top surface of the base material 301. The dotted lines illustrate cut pattern lines along which the protective layer 307 and the base material 301 are cut.

FIG. 3E(i) illustrates a top plan view of a top plan view of a portion of a polarizing structure 300E processed in accordance with action 210 in the flowchart 200 of FIG. 2, FIG. 3E(ii) illustrates a cross-sectional view of the polarizing structure 300E in FIG. 3E(i). For example, the polarizing structure 300D having the plurality of polarizing structures in FIG. 3D(i) are separated along the dotted lines, for example by sawing or cutting. As illustrated in FIG. 3E(ii), in an individual polarizing structure 300E (e.g., a polarizing plate), the protective layer 307 covers the inorganic layers 305 and the polarizer stack 398 over the base material 301. In one implementation, the protective layer 307 (e.g., a water-resistant layer) covers all of the sidewalls of the inorganic layers 305 and the polarizer stack 398.

According to an example implementation of the present disclosure, the plurality of panel sized pieces is cut out such that productivity is improved. Since the protective layer 307 covers the sidewalls of the panel sized piece, the sidewalls are protected from outside forces such as water. The outside forces such as water would infiltrate, erode, and/or dissolve the otherwise exposed sidewalls (e.g., cross-sections) over time if the sidewalls were left unprotected. Therefore, a preventive measure to prevent infiltration of outside forces such as water is required by providing the protective layer 307 to cover the cross section. When the plurality of panel sized pieces is cut out, accuracy such as patterning required for a thin line such as comb filed electrodes of the liquid crystal panel is not required.

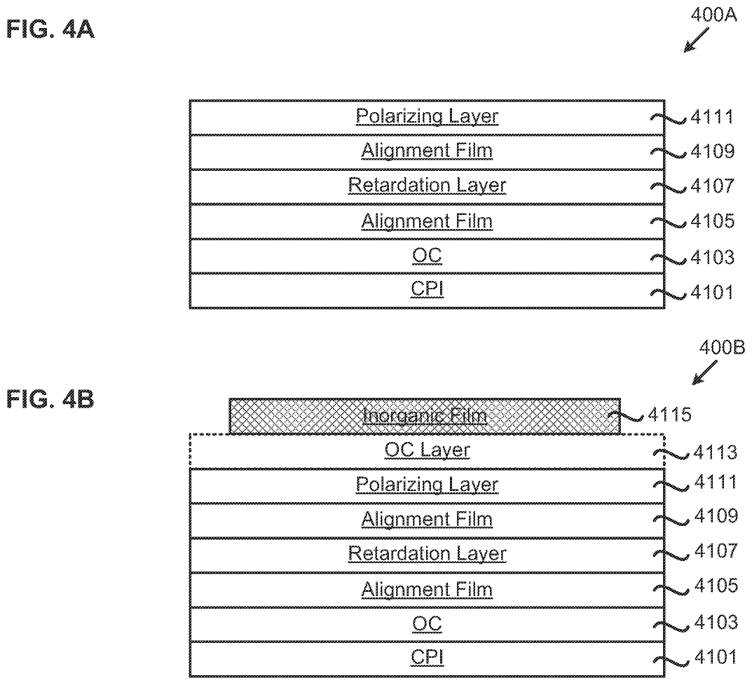

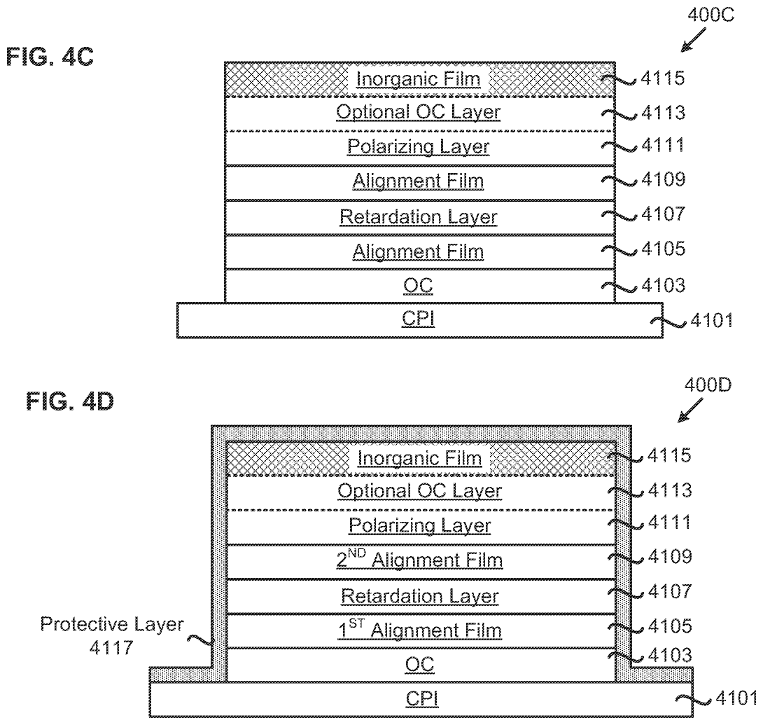

FIGS. 4A-4E each illustrate a portion of a polarizing structure processed in accordance with an example fabrication method of the present disclosure.

FIG. 4A illustrates a cross-sectional view of a portion of a polarizing structure 400A processed in accordance with the fabrication method of the present disclosure. In the polarizing structure 400A, a base material 4101 forms a base layer. The base material 4101 may include, but is not limited to, a transparent substrate such as a polyimide (e.g., CPI), epoxy resin, polycarbonate, polyethylene terephthalate (PET), direct OLED panel, and a surface glass for an LCD panel. An overcoating layer 4103 is provided on top of the base material 4101. The overcoating layer 4103 may include an organic or inorganic material. A first alignment film 4105 is provided on top of the overcoating layer 4103. A retardation layer 4107 is provided on top of the first alignment film 4105. A second alignment film 4109 is provided on top of the retardation layer 4107. The second alignment film 4109 may include, but is not limited to a lyotropic liquid crystal type. The second alignment film 4109 is necessary when a liquid crystal is used in a polarizing layer 4111, but may not be necessary in other cases. The polarizing layer 4111 is provided (e.g., laminated) on top of the second alignment film 4109.

FIG. 4B illustrates a cross-sectional view of a portion of a polarizing structure 400B processed in accordance with the fabrication method of the present disclosure. In FIG. 4B, another overcoating layer 4113 is provided on top of the polarizing layer 4111. Also, a patterned protective film 4115 is formed on the overcoating layer 4113. In one implementation, the overcoating layer 4113 may be optional.

FIG. 4C illustrates a cross-sectional view of a portion of a polarizing structure 400C processed in accordance with the fabrication method of the present disclosure. In FIG. 4C, portions of the polarizing structure 400B in FIG. 4B not covered by the patterned protective film 4115 are removed by dry etching. It should be noted that, the patterned protective film 4115 may include organic or inorganic material. In a case that an organic material is used for the patterned protective film 4115, the patterned protective film may be etched during the dry etching process such that the thickness of the remaining patterned protective film 4115 may be in the nanometer range or less. The base material 4001 is not etched during the dry etching process. The patterned protective film 4115 may preferably have a light transmittance of 85% or more after etching. By adjusting the light transmittance during determining film thickness and etching of the patterned protective film 4115, the patterned protective film 4115 may be having a thickness of, but not limited to, 500 nm or less after etching. Preferably, the thickness of the patterned protective film 4115 after etching may be in a range of 50 to 500 nm for the maximum water resistance effect.

FIG. 4D illustrates a cross-sectional view of a portion of a polarizing structure 400D processed in accordance with the fabrication method of the present disclosure. In FIG. 4D, a protective layer 4117 is provided on the polarizing structure 400C in FIG. 4C. In this example implementation, the protective layer 4117 is a conforming layer covering the top surface of the patterned protective film 4115, and all sides of the overcoating layer 4103, the first alignment film 4105, the retardation layer 4107, the second alignment film 4109, the polarizing layer 4111, the overcoating layer 4113, and the patterned protective film 4115. The protective layer 4117 also covers the top surface of the base material 4101. The protective layer 4117 is provided to prevent dissolution of the polarizing layer 4111 by the invasion of water coming from the cross section after etching. The protective layer 4117 may include, but is not limited to, acrylate resin, epoxy resins and the like. The protective layer 4117 may also serve as a hard coating having surface hardness and anti-fouling properties.

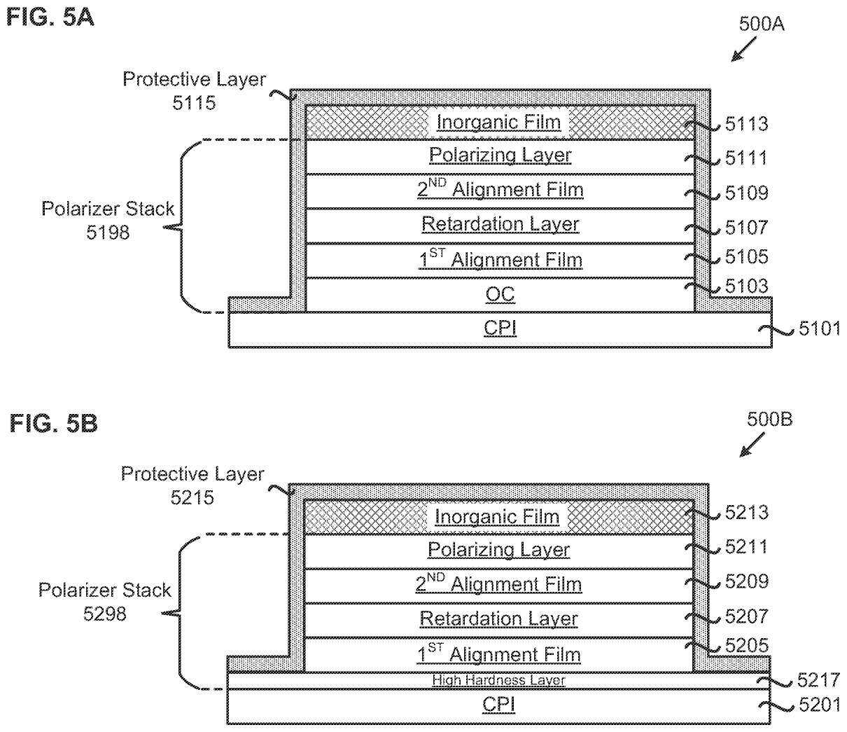

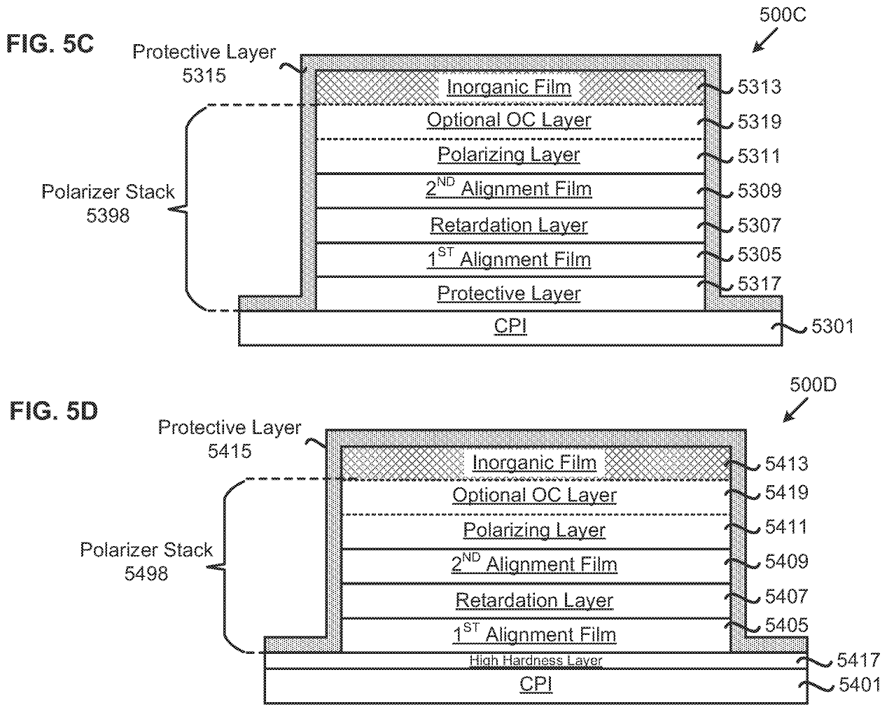

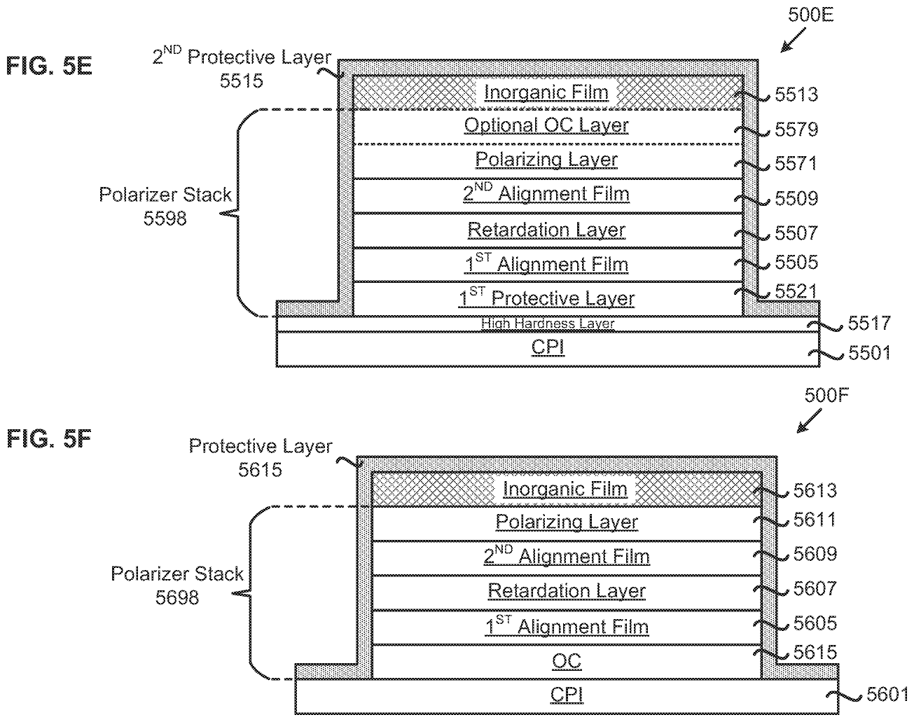

FIGS. 5A-5F each illustrate a polarizing structure including a polarizer stack provided on a base material and a conforming protective layer covering the polarizer stack and the base material according to an example implementation of the present disclosure.

FIG. 5A illustrates a cross-sectional view of a polarizing structure 500A having a protective layer according to an example implementation of the present disclosure. As illustrated in FIG. 5A, the polarizing structure 500A includes an overcoating layer 5103, a first alignment film 5105, a retardation layer 5107, a second alignment film 5109, and a polarizing layer 5111 in this order, provided on top of a base material 5101 (e.g., a CPI layer). The polarizing structure 500A also includes an inorganic layers 5113 on top of the polarizing layer 5111. The base material 5101, the polarizer stack 5198, and the inorganic layers 5113 are coated with a protective layer 5115.

FIG. 5B illustrates a cross-sectional view of a polarizing structure 500B having a protective layer according to an example implementation of the present disclosure. As illustrated in FIG. 5B, the polarizing structure 500B includes a polarizer stack 5298 having a high hardness layer 5217, a first alignment film 5205, a retardation layer 5207, a second alignment film 5209, and a polarizing layer 5211 in this order, provided on top of a base material 5201 (e.g., a CPI layer). The polarizing structure 500B also includes an inorganic layers 5213 on top of the polarizing layer 5211. The base material 5201, the polarizer stack 5298, and the inorganic layers 5213 are coated with the protective layer 5215. The high hardness layer 5217 preferably has a light transmittance of 85% or more, and preferably is an inorganic layers such as SiO₂, SiN, ITO, and SiON. In some implementations, the high hardness layer 5217 is not necessary when the base material 5201 is made with a hard material and is not affected during etching. The high hardness layer 5217 covers the entire surface of the base material 5201.

FIG. 5C illustrates a cross-sectional view of a polarizing structure 500C having a protective layer according to an example implementation of the present disclosure. As illustrated in FIG. 5C, the polarizing structure 500C includes a polarizer stack 5398 including a protective layer 5317, a first alignment film 5305, a retardation layer 5307, a second alignment film 5309, a polarizing layer 5311, and an overcoating layer 5319 (e.g., an optional layer) in this order, provided on top of a base material 5301. The polarizing structure 500C also includes an inorganic layers 5313 on top of the overcoating layer 5319. The base material 5301, the polarizer stack 5398, and the inorganic layers 5313 are coated with the protective layer 5315.

FIG. 5D illustrates a cross-sectional view of a polarizing structure 500D having a protective layer according to an example implementation of the present disclosure. As illustrated in FIG. 5D, the polarizing structure 500D includes a first alignment film 5405, a retardation layer 5407, a second alignment film 5409, a polarizing layer 5411, and an overcoating layer 5419 (e.g., an optional layer) in this order, provided on top of a base material 5401 (e.g., a CPI layer). The polarizing structure 500D also includes an inorganic layers 5413 on top of the overcoating layer 5419. The high hardness layer 5417 is provided in between the base material 5401 and the polarizer stack 5498. The base material 5401, the high hardness layer 5417, the polarizer stack 598, and the inorganic layers 5413 are coated with the protective layer 5415.

FIG. 5E illustrates a cross-sectional view of a polarizing structure 500E having a protective layer according to an example implementation of the present disclosure. As illustrated in FIG. 5E, the polarizing structure 500E includes a polarizer stack 5598, including a first protective layer 5521, a first alignment film 5505, a retardation layer 5507, a second alignment film 5509, a polarizing layer 5511, and an overcoating layer 5519 (e.g., an optional layer) in this order, provided on top of the base material 5501. The polarizing structure 500E also includes an inorganic layer 5513 on top of the overcoating layer 5519. The high hardness layer 5517 is provided in between the base material 5501 and the polarizer stack 5598. The base material 5501, the high hardness layer 5517, the polarizer stack 5598, and the inorganic layer 5513 are coated with a conforming second protective layer 5515.

FIG. 5F illustrates a cross-sectional view of a polarizing structure 500F having a protective layer according to an example implementation of the present disclosure. As illustrated in FIG. 5F, the polarizing structure 500F includes a polarizer stack 5698, including an overcoating layer 5615, a first alignment film 5605, a retardation layer 5607, a second alignment film 5609, and a polarizing layer 5611 in this order, provided on top of the base material 5601. The polarizing structure 500F also includes an inorganic layer 5613 on top of the polarizing layer 5611. The base material 5601, the polarizer stack 5698, and the inorganic layer 5613 are coated with the conforming protective layer 5615.

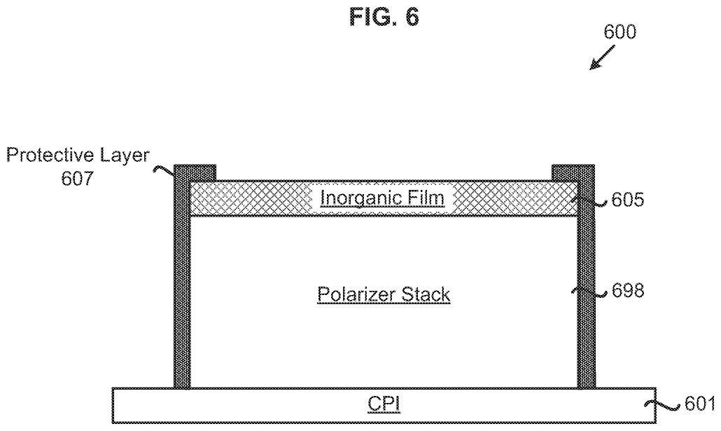

FIG. 6 illustrates a cross-sectional view of a polarizing structure 600 having a protective layer according to an example implementation of the present disclosure. As illustrated in FIG. 6, the polarizing structure 600 includes a polarizer stack 698 and an inorganic layer 605 provided on top of a base material 601 (e.g., a CPI layer). The base material 601 serves as the base layer. A protective layer 607 (e.g., a water resistant layer) is provided to cover the ends of the polarizer stack 698 and the inorganic layer 605. In one implementation, the inorganic layer 605 is water resistant. In one implementation, the protective layer 607 may serve as a decorative printing by using a black inorganic layer.

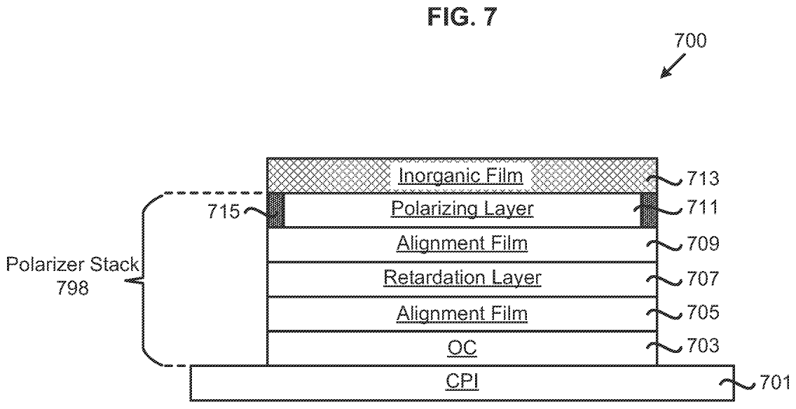

FIG. 7 illustrates a cross-sectional view of a polarizing structure 700 according to an example implementation of the present disclosure. The polarizing structure 700 includes a polarizer stack 798 provided on top of a base material 701 (e.g., a CPI layer). The polarizer stack 798 includes an overcoating layer 703, a first alignment film 705, a retardation layer 707, a second alignment film 709, and a polarizing layer 711 in this order. An inorganic layer 713 is provided on top of the polarizing layer 711. In the present implementation, the end portions 715 of the polarizing layer 711 are subjected to insolubilization treatment solution. The insolubilization treatment solution is applied through an insolubilization process. As a result of the insolubilization process, the end portions 715 of the polarizing layer 711 are water insoluble, thereby protecting the polarizing layer 711 from water infiltration, erosion, and/or dissolution.

In various implementations of the present application, a base material may include polyimide (e.g., CPI), epoxy resin, polycarbonate, polyethylene terephthalate (PET), etc. In some implementations of the present application, a direct OLED panel, a surface glass for an LCD panel may be a base material.

In various implementations of the present application, a high hardness layer may have a light transmittance 85% or more. Since the hardness is required, it is preferably an inorganic layer such as SiO₂, SiN, ITO, SiON.

In various implementations of the present application, a protective layer is provided to prevent melting the functional layers of the base material (e.g., configurations illustrated in FIGS. 5C and 5E). When providing an inorganic layer as a high hardness layer, the protective layer may not be necessary. In some implementations, a protective layer may be provided above or below the high hardness layer to flatten the top surface of the base material. The protective layer is not dissolved in a solvent of the alignment film above the protective layer. The protective layer may preferably have a light transmittance 90% or more. In various implementations, the protective layer may include, but is not limited to, acrylate resins, urethane resins, epoxy resins, and the like.

In various implementations of the present application, an alignment film may be necessary for a retardation layer but may not be necessary for a polarizing layer.

In various implementations of the present application, a retardation layer may not be necessary for a polarizing layer.

In various implementations of the present application, when using liquid crystals (e.g., Lyotropic liquid crystals) in a polarizing layer, an alignment film may be necessary for the polarizing layer, as such type of liquid crystals are to be oriented by shear stress. In other implementations, an alignment film may not be required for the polarizing layer.

In various implementations of the present application, a polarizing layer having Lyotropic liquid crystals may be formed by die coating techniques such as slit coating and spin coating.

In various implementations of the present application, an overcoating layer may be used for protecting the polarizing layer from the inorganic layer. During the formation of the inorganic layer, film floating of the polarizing layer may occur. Thus, a overcoating layer over the polarizing layer may be necessary to protect the polarizing layer. In some implementations, if the inorganic layer does not adversely affect the polarizing layer, then the overcoating layer may not be necessary.

In various implementations of the present application, in display applications, the decrease in color coloring and transmittance is not preferable. Thus, the inorganic layer is preferably a light transmittance of 85% or more after etching. By adjusting the etching rate of the inorganic layer, the inorganic layer may have a thickness of 0 nm in the final form after etching. In some implementations, for the purposes of providing better hardness and improving water resistance, the thickness of the inorganic layer after etching may be between 50 nm to 500 nm.

In various implementations of the present application, a conforming protective layer may be applied to prevent the polarizing layer from water damage, such as water infiltration, erosion, and/or dissolution, on the cross-sections of the polarizing layer after patterning. In various implementations, the protective layer may include, but is not limited to, acrylate resin, epoxy resins, and the like.

Thus, various implementations of the present application prevent water damage on the cross-sections of a patterned polarizing layer to overcome the deficiencies in the art. From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A polarizing plate, comprising:
a polarizing layer over a base material;
an inorganic insulation layer over the polarizing layer; and
a water-resistant layer over the inorganic insulation layer,
wherein the water-resistant layer covers sidewalls of the polarizing layer and sidewalls of the inorganic insulation layer, when the base material is viewed from a top plan view.

2. The polarizing plate of claim 1, wherein:
the water-resistant layer surrounds the sidewalls of the inorganic insulation layer and covers an entire surface of each of the sidewalls of the inorganic insulation layer, when viewed from the top plan view.

3. The polarizing plate of claim 1, further comprising a retardation layer between the base material and the polarizing layer.

4. The polarizer plate of claim 1, wherein the inorganic insulation layer has a light transmittance of equal to or greater than 85%.

5. The polarizer plate of claim 1, further comprising a protective layer between the inorganic insulation layer and the polarizing layer.

6. The polarizer plate of claim 1, further comprising another inorganic insulation layer between the polarizing layer and the base material.

7. The polarizer plate of claim 1, wherein the water-resistant layer further covers at least a portion of a top surface of the inorganic insulation layer, and has a light transmittance of equal to or greater than 90%.

8. The polarizer plate of claim 1, wherein the water-resistant layer includes a black water-resistant member having an optical density (OD) value of equal to or greater than 5.

9. The polarizer plate of claim 1, wherein the base material includes at least one of:
a colorless polyimide (CPI) layer;
a glass substrate; and
a display panel.

10. The polarizer plate of claim 1, wherein the inorganic insulation layer includes at least one of:
silicon dioxide;
silicon nitride;
silicon oxynitride; and
indium tin oxide.

11. A method of manufacturing a polarizing plate, the method comprising
forming a polarizing layer over a base material;
forming a plurality of patterned insulation layers over the polarizing layer;
removing portions of the polarizing layer not covered by the plurality of patterned insulation layers to form a plurality of polarizer stacks under the plurality of patterned insulation layers on the base material, each of the plurality of polarizer stacks having the polarizing layer;
forming a water-resistant layer on patterned sidewalls of at least one of the plurality of polarizer stacks, when the base material is viewed from a top plan view.

12. The method of claim 11, wherein the portions of the polarizing layer not covered by the plurality of patterned insulation layers are removed by dry or wet etching.

13. The method of claim 12, wherein the water-resistant layer partially or entirely covers the patterned sidewalls of the at least one of the plurality of polarizer stacks.

14. The method of claim 11, wherein the at least one of the plurality of polarizer stacks further comprises a retardation layer between the base material and the polarizing layer.

15. The method of claim 11, wherein the at least one of the plurality of polarizer stacks further comprises a protective layer between the inorganic insulation layer and the polarizing layer.

16. The method of claim 11, wherein the at least one of the plurality of polarizer stacks further comprises another inorganic insulation layer between the polarizing layer and the base material.

17. The method of claim 11, wherein the water-resistant layer covers at least a portion of a top surface of at least one of the plurality of patterned insulation layers.

18. The method of claim 11, further comprising performing an insolubilization process to patterned sidewalls of the polarizing layer using an insolubilization processing solution to make the patterned sidewalls of the polarizing layer water insoluble.

19. The method of claim 11, wherein the base material includes at least one of:
a colorless polyimide (CPI) layer;
a glass substrate; and
a display panel.

20. The method of claim 11, wherein the plurality of patterned insulation layers includes at least one of:
silicon dioxide;
silicon nitride;
silicon oxynitride; and
indium tin oxide.
